(19) United States
(12) Patent Application Publication
(10) Pub. No.: US 2017/0168725 A1
(43) Pub. Date: Jun. 15, 2017

(54) MEMORY SYSTEM THAT UPDATES FIRMWARE IN RESPONSE TO PREDETERMINED EVENTS

(71) Applicant: KABUSHIKI KAISHA TOSHIBA, Tokyo (JP)

(72) Inventors: Masaaki TAMURA, Chigasaki Kanagawa (JP); Masami AIHARA, Kawasaki Kanagawa (JP); Tetsuji HARADA, Kawasaki Kanagawa (JP)

(21) Appl. No.: 15/139,165

(22) Filed: Apr. 26, 2016

Related U.S. Application Data
(60) Provisional application No. 62/265,674, filed on Dec. 10, 2015.

(51) Int. Cl. G06F 3/06

(52) U.S. Cl. CPC G06F 3/0607; G06F 3/0688; G06F 3/065; G06F 3/0619; G06F 3/0659

(57) ABSTRACT

A memory system includes a nonvolatile memory including first and second regions for storing firmware and a controller configured to access the nonvolatile memory based on a command from a host device. When the controller receives new firmware along with an update command and old firmware is stored in the first region, the controller stores the new firmware in the second region. When execution of firmware is triggered by an event specified by the update command after the new firmware has been stored, the controller executes the new firmware. When execution of firmware is triggered by an event that is not specified by the update command after the new firmware has been stored, the controller executes the old firmware.

### CROSS-REFERENCE TO RELATED APPLICATIONS

This application is based upon and claims the benefit of priority from U.S. Provisional Patent Application No. 62/265,674, filed on Dec. 10, 2015, the entire contents of which are incorporated herein by reference.

### FIELD

Embodiments described herein relate generally to a memory system, in particular, a memory system that updates firmware in response to predetermined events.

### BACKGROUND

Use of memory systems including a nonvolatile memory has become widespread. As one of these memory systems, a solid state drive (SSD) including a NAND flash memory (NAND memory) is known. The SSD is used as a main storage of various data processing devices.

The SSD typically includes a controller which controls elements of the SSD, specifically, which controls the access to the NAND memory in response to a request from a host device. The controller operates to perform the control based on firmware stored in the NAND memory, for example (in other words, by loading firmware from the NAND memory and executing the firmware). The SSD preferably has a mechanism for updating firmware, in which an operation procedure of the controller is described, at a timing desired by a user thereof.

### BRIEF DESCRIPTION OF THE DRAWINGS

FIG. 1 illustrates a configuration of a memory system according to an embodiment.

FIG. 2 illustrates a structural example of a block of a memory cell array in the memory system.

FIG. 3 illustrates a format of a WRITE BUFFER command defined in the SCSI standard.

FIG. 4 illustrates details of a MODE SPECIFIC field included in the WRITE BUFFER command shown in FIG. 3.

FIG. 5 illustrates details of a MODE field included in the WRITE BUFFER command shown in FIG. 3.

FIG. 6 illustrates an operation performed by a peripheral device (SCSI device) when a WRITE BUFFER command in which the content of the MODE field is 04h or 06h is received.

FIG. 7 illustrates an operation performed by a peripheral device (SCSI device) when a WRITE BUFFER command in which the content of the MODE field is 0Dh or 0Eh is received.

FIG. 8 illustrates an operation performed by a peripheral device (SCSI device) when an event to cause firmware received by a WRITE BUFFER command in which the content of the MODE field is 0Dh or 0Eh to be loaded and activated occurs.

FIG. 9 illustrates an operation performed by a peripheral device (SCSI device) when a WRITE BUFFER command in which the content of the MODE field is 05h or 07h is received.

FIG. 10 illustrates an operation performed by a controller incorporated in the memory system of the embodiment when a WRITE BUFFER command in which the content of the MODE field is 0Dh is received.

FIG. 11 illustrates an operation performed by the controller when firmware is loaded and activated due to an event other than an event specified in advance.

FIG. 12 illustrates an operation performed by the controller when firmware is loaded and activated due to an event specified in advance.

FIG. 13 illustrates transition of operational states of two storage areas in a NAND memory corresponding to transition of an operational state of the memory system shown in FIG. 10 to FIG. 12.

FIG. 14 is a flowchart showing a flow of an operation performed by the memory system of the embodiment when a WRITE BUFFER command in which the content of the MODE field is 05h or 07h is received.

FIG. 15 is a flowchart showing a flow of an operation performed by the memory system of the embodiment when a WRITE BUFFER command in which the content of the MODE field is 0Dh or 0Eh is received.

FIG. 16 is a flowchart showing a flow of an operation performed by the memory system of the embodiment when a power-on event occurs.

FIG. 17 is a flowchart showing a flow of an operation performed by the memory system of the embodiment when an event (for causing firmware to be loaded and activated) other than a power-on event occurs in a state where new unapplied firmware is present.

### DETAILED DESCRIPTION

In general, according to an embodiment, a memory system includes a nonvolatile memory including first and second regions for storing firmware and a controller configured to access the nonvolatile memory based on a command from a host device. When the controller receives new firmware along with an update command and old firmware is stored in the first region, the controller stores the new firmware in the second region. When execution of firmware is triggered by an event specified by the update command after the new firmware has been stored, the controller executes the new firmware. When execution of firmware is triggered by an event that is not specified by the update command after the new firmware has been stored, the controller executes the old firmware.

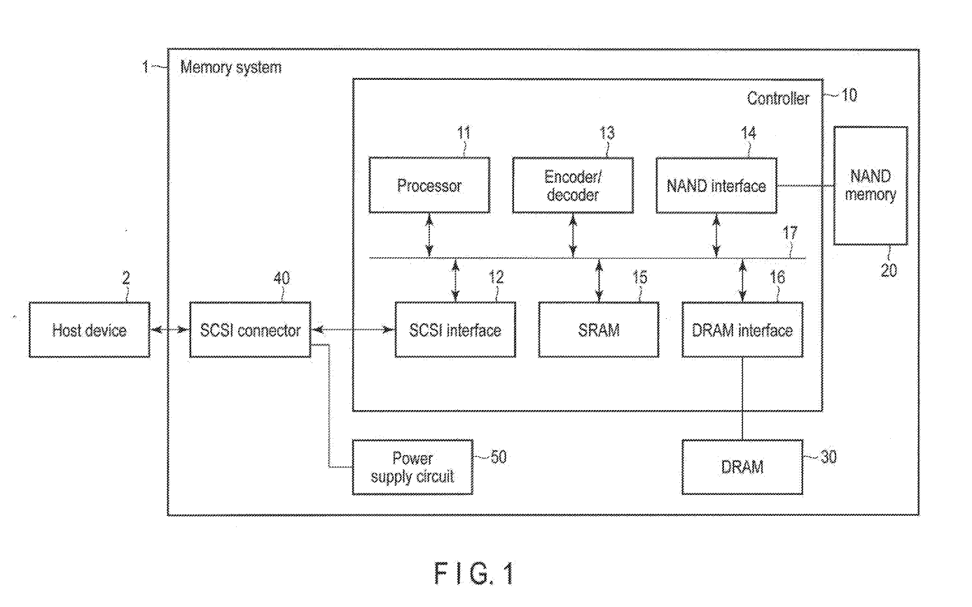

FIG. 1 illustrates a configuration of a memory system 1 according to an embodiment. The memory system 1 is a storage device configured to write data into a nonvolatile memory and read data from the nonvolatile memory. The memory system 1 includes, for example, an SSD including a NAND memory 20. Here, the NAND memory 20 is used as an example of the nonvolatile memory. However, a nonvolatile semiconductor memory other than the NAND memory 20 may be used. For example, a flash memory having a three-dimensional structure, a resistance random access memory (ReRAM) or a ferroelectric random access memory (FeRAM) may be used.

The memory system 1 is used as an external storage device of a host device 2. The host device 2 may be, for example, a data processing device such as a personal computer, a server, a mobile phone, an imaging device, a portable terminal such as a tablet computer or a smartphone, a games console, or an in-car terminal such as a car navigation system.

Here, it is assumed that an interface conforming to the small computer system interface (SCSI) standard such as a serial attached SCSI (SAS) is employed as an interface for mutually connecting the memory system 1 and the host device 2. In the SCSI standard, a command for updating firmware (microcode) of a peripheral device is defined. The memory system 1 of the present embodiment updates firmware at timing desired by a user in accordance with the command.

As shown in FIG. 1, the memory system 1 includes a controller 10, the NAND memory 20, a dynamic random access memory (DRAM) 30, a SCSI connector 40, a power supply circuit 50, etc.

The controller 10 controls structural elements of the memory system 1. When the controller 10 receives a command from the host device 2 via the SCSI connector 40, the controller 10 performs control in accordance with the command. The controller 10 includes a processor 11, an SCSI interface 12, an encoder/decoder 13, a NAND interface 14, a static random access memory (SRAM) 15, and a DRAM interface 16, etc. The processor 11, the SCSI interface 12, the encoder/decoder 13, the NAND interface 14, the SRAM 15m and the DRAM interface 16 are mutually connected via a bus 17.

The NAND memory 20 includes at least one memory chip including a memory cell array. The memory cell array includes a plurality of memory cells arranged in a matrix configuration. The memory cell array includes a plurality of blocks, wherein one block is a unit of data deletion. Each block is composed of a plurality of physical sectors.

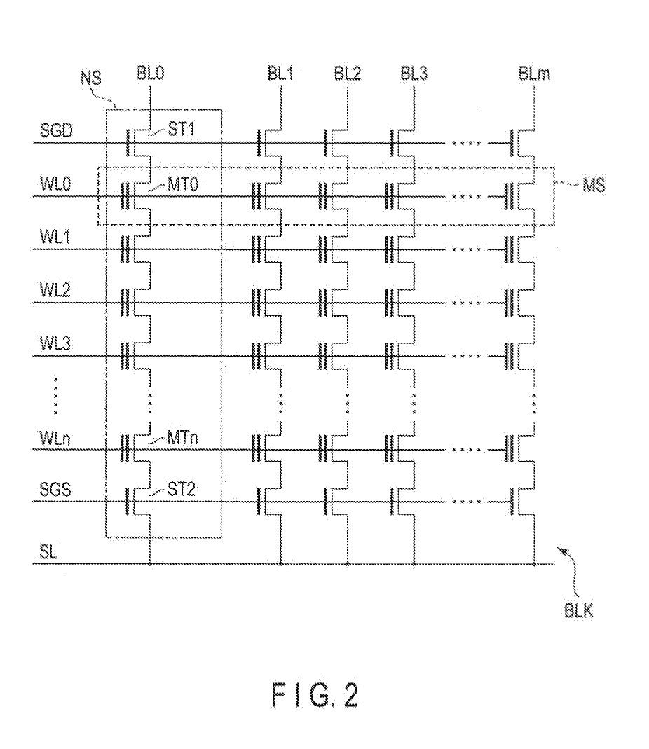

FIG. 2 illustrates a structural example of a block of a memory cell array. FIG. 2 shows one of the blocks forming a memory cell array. The other blocks of the memory cell array have the same structure as FIG. 2. As shown in FIG. 2, the block BLK of the memory cell array includes m+1 NAND strings NS, where m is an integer greater than or equal to zero. Each NAND string NS includes n+1 memory cell transistors MT0 to MTn connected in series such that a diffusion region (a source region or a drain region) is shared by adjacent memory cell transistors MT, where n is an integer greater than or equal to zero. Each NAND string NS further includes select transistors ST1 and ST2 at both ends of the group of n+1 memory cell transistors MT0 to MTn.

Word lines WL0 to WLn are connected to the control gate electrodes of the memory cell transistors MT0 to MTn of each NAND string NS, respectively. Memory cell transistors MTi (i=0 to n) of the NAND strings NS are commonly connected to the same word line WLi (i=0 to n). In the block BLK, the control gate electrodes of memory cell transistors MTi in the same row are connected to the same word line WLi.

Each of memory cell transistors MT0 to MTn is formed of a field-effect transistor having a stacked gate structure formed on a semiconductor substrate. The stacked gate structure includes a charge storage layer (floating gate electrode) formed with intervention of a gate insulating film on the semiconductor substrate, and a control gate electrode formed with intervention of an inter-gate insulating film on the charge storage layer. In memory cell transistors MT0 to MTn, the threshold voltage is changed in accordance with the number of electrons stored in the floating gate electrode. Memory cell transistors MT0 to MTn are capable of storing data in accordance with difference in the threshold voltage.

Bit lines BL0 to BLm are respectively connected to the drains of m+1 select transistors ST1 in a single block BLK. Select gate line SGD is commonly connected to the gates of m+1 select transistors ST1 in the block BLK. The source of select transistor ST1 is connected to the drain of memory cell transistor MT0. Similarly, a source line SL is commonly connected to the sources of m+1 select transistors ST2 in the block BLK. Select gate line SGS is commonly connected to the gates of m+1 select transistors ST2 in the block BLK. The drain of select transistor ST2 is connected to the source of memory cell transistor MTn.

Each memory cell is connected to a word line as well as a bit line. Each memory cell can be identified by an address of the word line and an address of the bit line. As described above, data stored in a plurality of memory cells (memory cell transistors MT) in the same block BLK is deleted in a lump. In contrast, data are read and written in unit of page. When each memory cell is capable of storing only binary data, one page corresponds to one physical sector MS including a plurality of memory cells connected to a single word line.

When each memory cell is capable of storing multi-value data and operates in a single-level cell (SLC) mode, one physical sector MS corresponds to one page. When each memory cell operates in a multi-level cell (MLC) mode, one physical sector MS corresponds to N pages, where N is a natural number greater than or equal to two. When N is equal to two, one physical sector MS corresponds to two pages. When N is equal to three, one physical sector MS corresponds to three pages.

In a read operation and a program (write) operation, one word line is selected in accordance with a physical address, and as a result one physical sector MS is selected. In the physical sector MS, page switching is performed based on a physical address.

The NAND memory 20, which includes at least one memory chip of the above structure, is connected to the NAND interface 14 of the controller 10 as shown in FIG. 1.

In FIG. 1, the DRAM 30 functions as a buffer for transferring write data and read data between the host device 2 and the NAND memory 20. The memory system 1 may include a magnetoresistive random access memory (MRAM) or a ferroelectric random access memory (FeRAM) in place of the DRAM 30. The DRAM 30 is connected to the DRAM interface 16 of the controller 10.

The SCSI connector 40 is a link unit for connecting the host device 2 and the memory system 1. The SCSI connector 40 is connected to the SCSI interface 12 of the controller 10. For example, commands and user data from the host device 2 are received by the SCSI interface 12 via the SCSI connector 40. For example, user data read from the NAND memory 20 and a response from the controller 10 (to a command) are transferred to the host device 2 via the SCSI connector 40. The shape, etc., of the SCSI connector 40 is determined in conformity to the SCSI standard.

The power supply circuit 50 is connected to the host device 2 via the SCSI connector 40 and receives power from the host device 2 via the SCSI connector 40. The power supply circuit 50 is also connected to the controller 10, the NAND memory 20, and the DRAM 30 through a power supply line (not shown in FIG. 1). Thus, the power supply circuit 50 is capable of supplying power from the host device 2 to the controller 10, the NAND memory 20, and the DRAM 30.

Now, the processor 11, the SCSI interface 12, the encoder/decoder 13, the NAND interface 14, the SRAM 15 and the DRAM interface 16 in the controller 10 will be described.

For example, when the memory system 1 is activated, firmware stored in the NAND memory 20 is loaded into the SRAM of the controller 10 and the DRAM 30 separately. More specifically, modules related to processes which are frequently performed, and modules related to processes which require high responsiveness are loaded into the SRAM 15. Modules related to processes which are infrequently performed and do not require high responsiveness are loaded into the DRAM 30. In the firmware, the portions to be loaded into the SRAM 15 and the portions to be loaded into the DRAM 30 are determined in advance. The processor 11 performs a predetermined process in accordance with the firmware. The processor 11 only has to perform a predetermined process in accordance with firmware. For example, the processor 11 is a central processing unit (CPU). The SRAM 15 also functions as a storage area for various types of management data. One of these types of management data is used to control transferring write data and read data between the host device 2 and the NAND memory 20. The management data includes, for example, mapping data indicating a relationship between the logical address specified by the host device 2 and the storage position (physical address) in the NAND memory 20. Various types of management data (for example, update portions) in the SRAM 15 are stored in the NAND memory 20 at a predetermined timing (in other words, nonvolatile processing is carried out for the data).

For example, the processor 11 performs read processing to read data from the NAND memory 20 in accordance with a read command notified by the SCSI interface 12. The processor 11 performs the read processing by obtaining a physical position of the NAND memory 20 corresponding to the logical address of read data, from the management data stored in the SRAM 15 and notifying the NAND interface 14 of the obtained physical position. The processor 11 uses the DRAM 30 as a buffer of the read data. The read data are transferred to the host device 2 via the encoder/decoder 13 (decoder), the DRAM 30, and the SCSI interface 12. The processor 11 performs write processing to write data into the NAND memory 20 in accordance with a write command notified by the SCSI interface 12. The processor writes a code word produced by the encoder/decoder 13 (encoder) into the NAND memory 20. The processor 11 uses the DRAM 30 as a buffer for storing write data. The processor 11 registers the mapping of the logical address and the physical position in the NAND memory 20, in the management data stored in the SRAM 15.

The SCSI interface 12 performs communication for transferring, for example, a command, user data, and a response to a command between the host device 2 and the controller 10 connected via the SCSI connector 40, specifically, between the host device 2 and the processor 11.

The encoder/decoder 13 (encoder) first encodes the user data buffered in the DRAM 30 and produces a code word composed of data and a redundant portion (parity). Then, the encoder/decoder 13 (decoder) obtains a code word read from the NAND memory 20 from the NAND interface 14 and decodes the obtained code word. When error collection is unsuccessful, the encoder/decoder 13 notifies the processor 11 of a read error.

The NAND interface 14 directly controls data writing into the NAND memory 20 and data reading from the NAND 20 based on a command from the processor 11. The SRAM 15 functions as a storage area of firmware and various types of management data as described above. The DRAM interface 16 directly controls data writing into the DRAM 30 and data reading from the DRAM 30 based on a command from the processor 11.

Now, an operation performed by the controller 10 to update firmware at a timing desired by the user in accordance with a command from the host device 2 will be described.

As described above, in the present embodiment, it is assumed that an interface conforming to the SCSI standard is used as an interface for mutually connecting the memory system 1 and the host device 2. In the SCSI standard, a WRITE BUFFER command is defined as one of the commands for updating the firmware of a peripheral device.

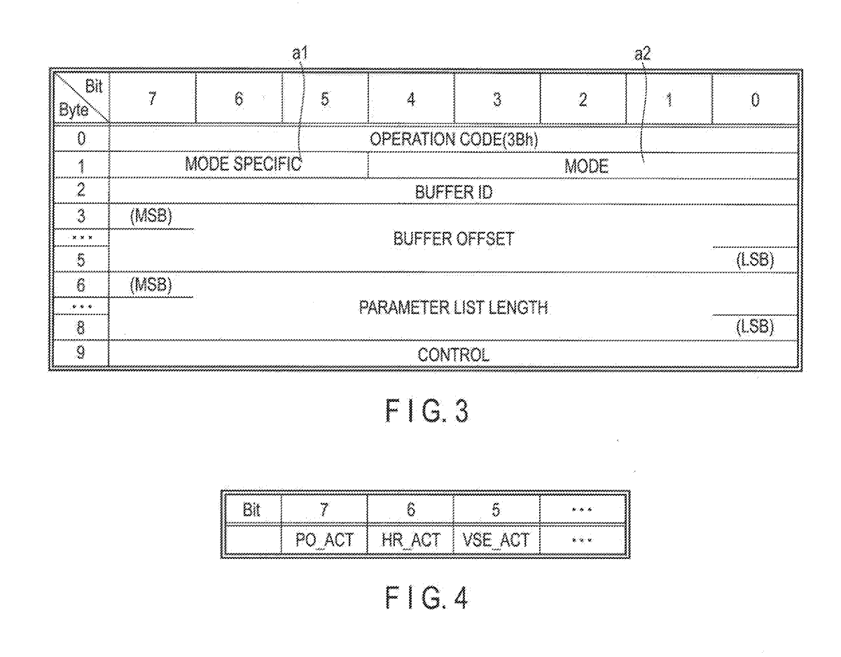

FIG. 3 illustrates a format of a WRITE BUFFER command defined in the SCSI standard.

As shown in FIG. 3, the WRITE BUFFER command includes a MODE SPECIFIC field (a1) and a MODE field (a2). The use of the MODE SPECIFIC field depends on the content of the MODE field. For example, when the content of the MODE field is 0Dh, the MODE SPECIFIC field is used. FIG. 4 illustrates details of the MODE SPECIFIC field. The WRITE BUFFER command in which the content of the MODE field is 0Dh is a command to transfer new firmware to a peripheral device and store the firmware therein. Moreover, the WRITE BUFFER command in which the content of the MODE field is 0Dh is a command to designate an event which should be the cause to replace the current firmware (old firmware) with the new firmware (in other words, the trigger to apply the new firmware) and may occur in the memory system 1. The MODE SPECIFIC field in this command is used to specify the event.

As shown in FIG. 4, the MODE SPECIFIC field includes a power-on-activate (PO_ACT) bit, a hard-reset-activate (HR_ACT) bit, and a vendor-specific-event-activate (VSE_ACT) bit.

The PO_ACT bit is a bit to indicate that a power-on event is a trigger to apply new firmware. When this bit is 1, new firmware is loaded upon the occurrence of a power-on event. In other words, when the PO_ACT bit is set to 0, the current firmware can be continuously applied regardless of the occurrence of the power-on event.

The HR_ACT bit is a bit to indicate that a hard-reset is a trigger to apply new firmware. When this bit is 1, new firmware is loaded upon the occurrence of a hard-reset event. In a manner similar to the PO_ACT bit, when the HR_ACT bit is set to 0, the current firmware can be continuously applied regardless of the occurrence of the hard-reset event.

The VSE_ACT bit is a bit to indicate that the event defined by a vendor is a trigger to apply new firmware. The event is defined by the vendor in advance. When this bit is 1, new firmware is loaded upon the occurrence of the event defined by the vendor. In a manner similar to the PO_ACT bit and the HR_ACT bit described above, when the VSE_ACT bit is set to 0, the current firmware can be continuously applied regardless of the occurrence of the event defined by the vendor.

In the PO_ACT bit, the HR_ACT bit, and the VSE_ACT bit, 1b may not be selectively set. Instead, 0b or 1b can be set to each of the PO_ACT bit, the HR_ACT bit, and the VSE_ACT bit. Thus, a plurality of events can be set as the trigger to apply new firmware.

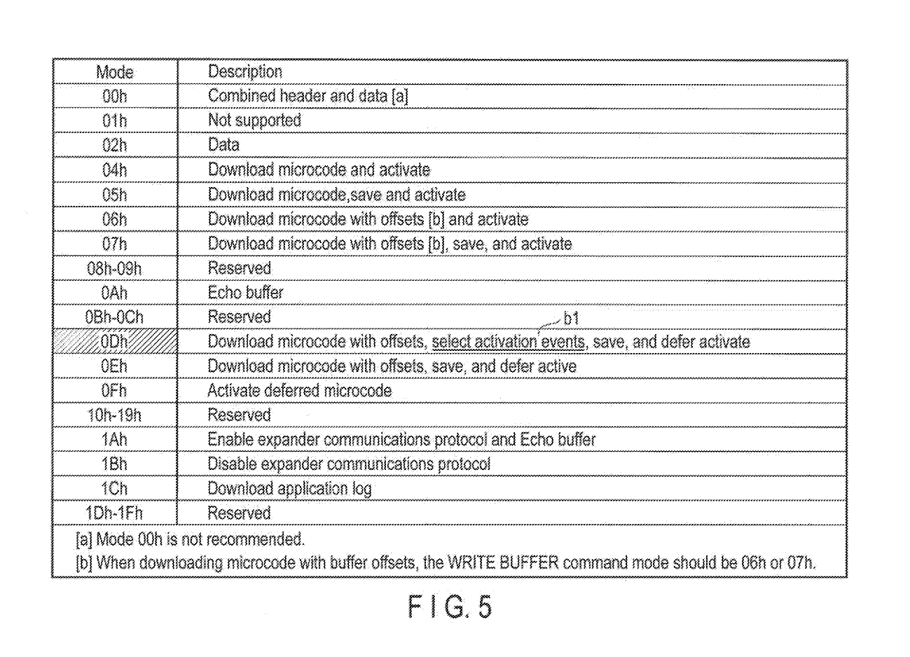

FIG. 5 illustrates the details of the MODE field.

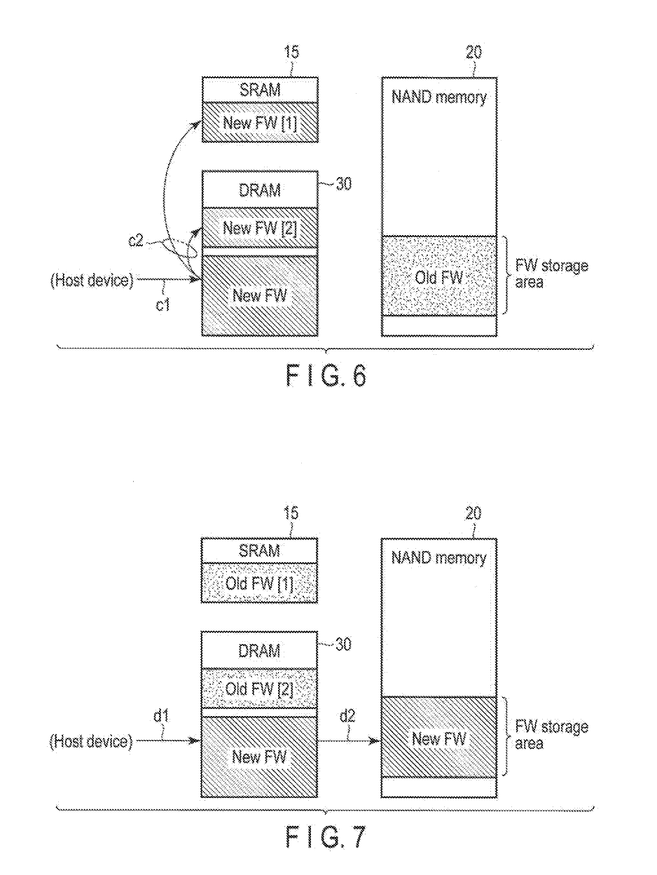

A WRITE BUFFER command in which the content of the MODE field is 04h or 06h is a command to transfer new firmware to a peripheral device and activate the firmware. Here, an example of a conventional operation performed by a peripheral device (SCSI device) when this command is received will be described with reference to FIG. 6. Here, an SSD (including an SRAM, a DRAM, and a NAND memory) is assumed to be a peripheral device that has a configuration similar to that of the memory system 1 of the present embodiment. To give simple description, the same structural elements as those of the memory system 1 of the present embodiment are described with the same reference numbers or symbols.

When the WRITE BUFFER command in which the content of the MODE field is 04h or 06h is received, the peripheral device temporarily stores the new firmware transferred with the WRITE BUFFER command in the DRAM 30 (c1 in FIG. 6). When the peripheral device has received the new firmware, the peripheral device checks the validity of data by, for example, a checksum. When the validity is confirmed, the peripheral device immediately loads and activates the new firmware (c2 in FIG. 6). As described above, modules of the firmware related to processes which are frequently performed and modules of the firmware related to processes which require high responsiveness are loaded into the SRAM 15. Further, modules of the firmware related to processes which are infrequently performed and do not require high responsiveness are loaded into the DRAM 30. This new firmware transferred with this WRITE BUFFER command is not stored in the NAND memory 20. Thus, for example, when the peripheral device is turned off, and is turned on again, the old firmware stored in the NAND memory 20 is loaded and activated.

Referring back to FIG. 5, a WRITE BUFFER command in which the content of the MODE field is 0Dh or 0Eh is a command to transfer new firmware to a peripheral device and store the firmware. An example of an operation performed by a peripheral device (SCSI device) when this command is received is described with reference to FIG. 7. In a manner similar to that of the memory system 1 of the present embodiment, an SSD (including an SRAM, a DRAM and a NAND memory) is assumed to be the peripheral device. To give simple description, the same structural elements as those of the memory system 1 of the present embodiment are described with the same reference numbers or symbols.

When the WRITE BUFFER command in which the content of the MODE field is 0Dh or 0Eh is received, the peripheral device temporarily stores the new firmware transferred with this WRITE BUFFER command in the DRAM 30 (d1 in FIG. 7). When the peripheral device has received the new firmware, the peripheral device checks the validity of data by, for example, a checksum. When the validity is confirmed, the peripheral device stores the new firmware in the NAND memory 20 (d2 in FIG. 7). When this WRITE BUFFER command is received, the loading or activation of the new firmware transferred with the WRITE BUFFER command is not performed at this point of time. Thus, the old firmware remains to be applied.

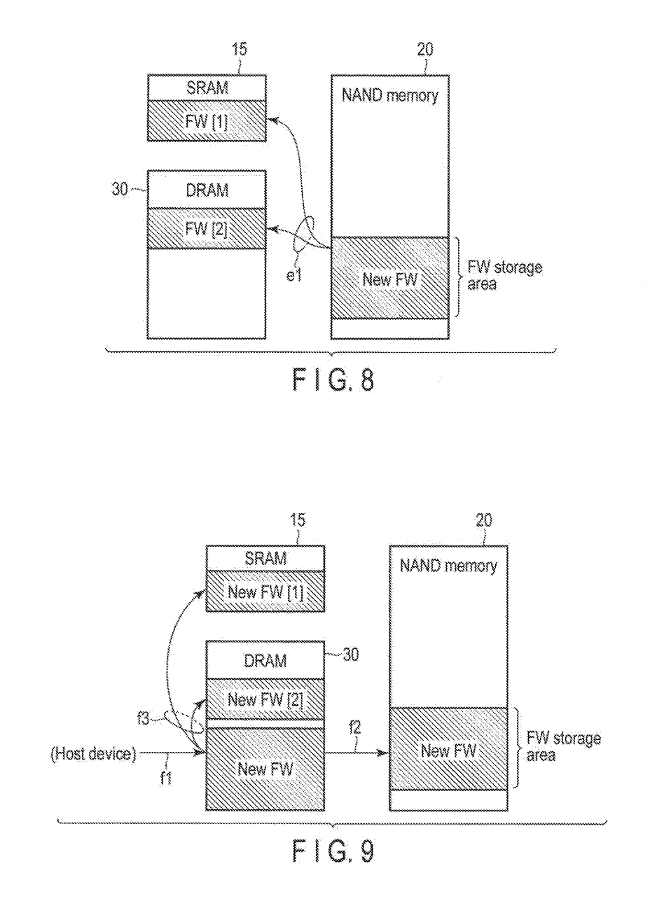

The new firmware transferred with this WRITE BUFFER command is loaded from the NAND memory 20 into the SRAM 15 and the DRAM 30 and is activated (e1 in FIG. 8) as shown in FIG. 8, upon the occurrence of an event determined in advance, such as power-on or hard reset, when the content of the MODE field is 0Eh. When the content of the MODE field is 0Dh, as described above, the new firmware is supposed to be loaded from the NAND memory 20 into the SRAM 15 and the DRAM 30 and activated only upon the occurrence of an event specified by the MODE SPECIFIC field (b1 in FIG. 5) in the SCSI standard. However, according to the conventional operation described above, when new firmware has already been stored in the NAND memory 20, the new firmware may be improperly loaded and activated at the time of loading and activating the firmware caused by an event other than the specified event. The memory system 1 of the present embodiment described below deals with this improper loading of firmware.

The new firmware transferred with this WRITE BUFFER command is loaded from the NAND memory 20 into the SRAM 15 and the DRAM 30 and activated as shown in FIG. 8 when a WRITE BUFFER command in which the content of the MODE field is 0Fh is received as well as when a predetermined event occurs.

Referring back to FIG. 5, a WRITE BUFFER command in which the content of the MODE field is 05h or 07h is a command to transfer new firmware to a peripheral device and store and activate the firmware. An example of an operation performed by a peripheral device (SCSI device) when this command is received is described with reference to FIG. 9. In a manner similar to that of the memory system 1 of the present embodiment, an SSD (including an SRAM, a DRAM and a NAND memory) is assumed to be the peripheral device. To give simple description, the same structural elements as those of the memory system 1 of the present embodiment are described with the same reference numbers or symbols.

When the WRITE BUFFER command in which the content of the MODE field is 05h or 07h is received, the peripheral device temporarily stores the new firmware transferred with this WRITE BUFFER command in the DRAM 30 (f1 in FIG. 9). When the peripheral device has received the new firmware, the peripheral device checks the validity of data by, for example, a checksum. When the validity is confirmed, firstly, the peripheral device stores the new firmware in the NAND memory (f2 in FIG. 9). Then, the peripheral device loads and activates the new firmware (f3 in FIG. 9). The storage of the new firmware in the DRAM 30 can be performed in parallel to the loading and activation of the new firmware. The loading and activation of the new firmware may be performed on the condition that the storage of the new firmware in the NAND memory 20 has completed normally.

In consideration of the above operations performed by a peripheral device (SCSI device) when various WRITE BUFFER commands are received, an operation performed by the memory system 1 of the present embodiment when a WRITE BUFFER command is received will be described below.

In the memory system 1 of the present embodiment, two storage areas for firmware are provided in the NAND memory 20. Alternatively, three or more storage areas for firmware may be provided. An operational state of each storage area is set to an active state, an invalid state, or a deferred state by the controller 10. In an active state, the firmware stored in the storage area is valid. In an invalid state, the firmware stored in the storage area is invalid, or no firmware is stored in the storage area. A deferred state is a waiting state until the stored firmware is validated. Initially, both of the two storage areas are in the invalid state. Alternatively, one of the storage areas may be in the active state, and the other may be in the invalid state.

The controller 10 operates in accordance with the following rules with respect to the two storage areas.

(1) The new firmware transferred from the host device 2 is stored in a storage area in a state (the invalid state or the deferred state) other than the active state. The storage area in which the new firmware is stored is set to the deferred state.

(2) When one of the two storage areas is set to the active state, the other one is set to the invalid state. When one of the two storage areas is set to the active state, it means that the new firmware stored in a storage area in the deferred state is loaded and activated.

Obviously, these rules are applied without exception when the content of the MODE field of a WRITE BUFFER command to transfer new firmware is any one of 05h, 07h, 0Dh, and 0Eh.

When a predetermined event to cause new firmware to be loaded from the NAND memory 20 into the SRAM 15 and the DRAM 30 and activated, such as power-on or hard reset, occurs, the controller 20 loads and activates the new firmware stored in the storage area that is in the deferred state, and loads and activates the current firmware stored in a storage area that is in the active state when no storage area is in the deferred state. When new firmware is loaded from a storage area in the deferred state and is activated, the operational state of the storage area is changed to the active state. Further, the operational state of the storage area in the active state is changed to the invalid state in accordance with the above rule (2). The operational state of each storage area is changed cyclically from the invalid state to the deferred state, and then to the active state, the cycle continuing indefinitely.

When new firmware is transferred with a WRITE BUFFER command in which the content of the MODE field is 0Dh, the controller 20 registers an event specified by the above MODE SPECIFIC field. Registration of the event refers to, for example, registration of the event in management data stored in the SRAM 15. As described above, various types of management data in the SRAM 15 (for example, update portions) are stored in the NAND memory 20 at a predetermined timing (in other words, nonvolatile processing is carried out for the data). Even when a storage area in the deferred state is present upon the occurrence of the predetermined event to cause firmware to be loaded from the NAND memory 20 into the SRAM 15 and the DRAM 30 and activated, the controller 20 exceptionally loads and activates the current firmware stored in a storage area in the active state instead of the new firmware stored in the storage area in the deferred state when the event is not the registered event. When the event is the registered event, the controller 20 loads and activates the new firmware stored in the storage area in the deferred state. In this manner, in accordance with the above rule (2), the operational state of the storage area in the deferred state is changed to the active state, and further the operational state of the storage area in the active state is changed to the invalid state. The controller 20 also loads and activates the new firmware stored in a storage area in the deferred state when a WRITE BUFFER command in which the content of the MODE field is 0Fh is received.

Thus, in the memory system 1 of the present embodiment, firmware can be updated at a timing desired by the user. More specifically, for example, it is possible to maintain to apply the current firmware at the time of hard reset and switch the firmware to new firmware at the time of power-on.

When no storage area is in the deferred state at the time of loading and activating firmware caused by the event specified by the MODE SPECIFIC field, the controller 20 loads and activates the current firmware stored in a storage area in the active state.

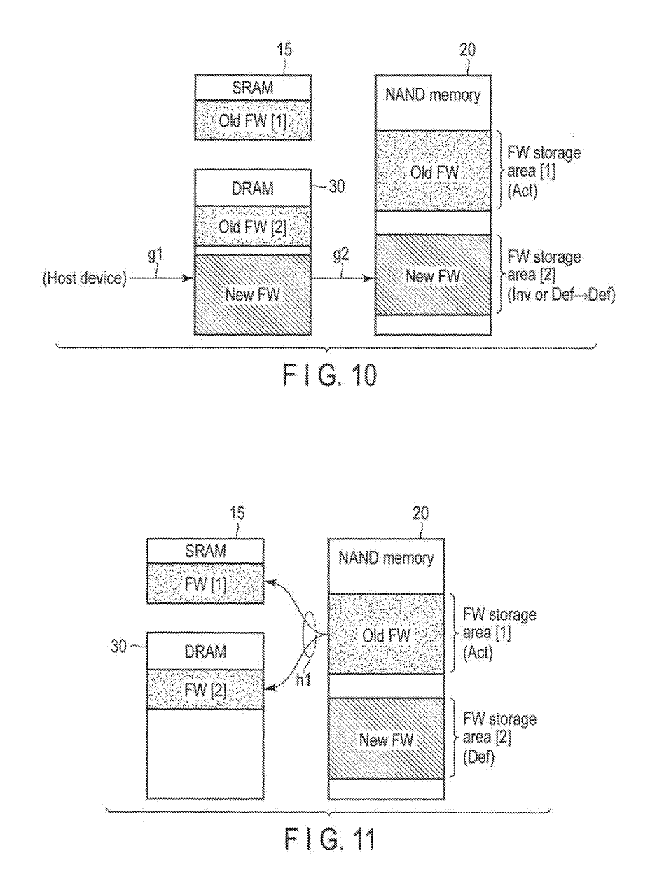

Below describes how the operational state of the memory system 1 of the present embodiment is changed under control of the controller 20 when a WRITE BUFFER command in which the content of the MODE field is 0Dh is received, referring to FIG. 10 to FIG. 12.

FIG. 10 illustrates an example of an operation performed by the controller 20 when a WRITE BUFFER command in which the content of the MODE field is 0Dh is received.

When the WRITE BUFFER command in which the content of the MODE field is 0Dh is received, the controller 20 temporarily stores the new firmware transferred with this WRITE BUFFER command in the DRAM 30 (g1 in FIG. 10). When the controller 20 has received the new firmware, the controller 20 checks the validity of data by, for example, a checksum. When the validity is confirmed, the controller 20 stores the new firmware in, out of the two storage areas in the NAND memory 20, a storage area which is not in the active (Act) state, in other words, a storage area in the invalid (Inv) state or the deferred (Def) state (g2 in FIG. 10). At this time, the controller 20 sets the operational state of the storage area in which the new firmware is stored to the deferred state. The controller 20 also registers the event specified by the MODE SPECIFIC field of the WRITE BUFFER command.

FIG. 11 illustrates an example of an operation performed by the controller 20 when firmware is loaded and activated (after new firmware is stored in the NAND memory 20 in accordance with a WRITE BUFFER command in which the content of the MODE field is 0Dh) upon an event other than the event specified by the MODE SPECIFIC field of the WRITE BUFFER command.

When firmware is loaded and activated upon an event other than the event which is registered at the time of reception of the WRITE BUFFER command in which the content of the MODE field is 0Dh and which is specified by the MODE SPECIFIC field of the WRITE BUFFER command, the controller 20 loads and activates the current firmware stored in a storage area in the active state (h1 in FIG. 11).

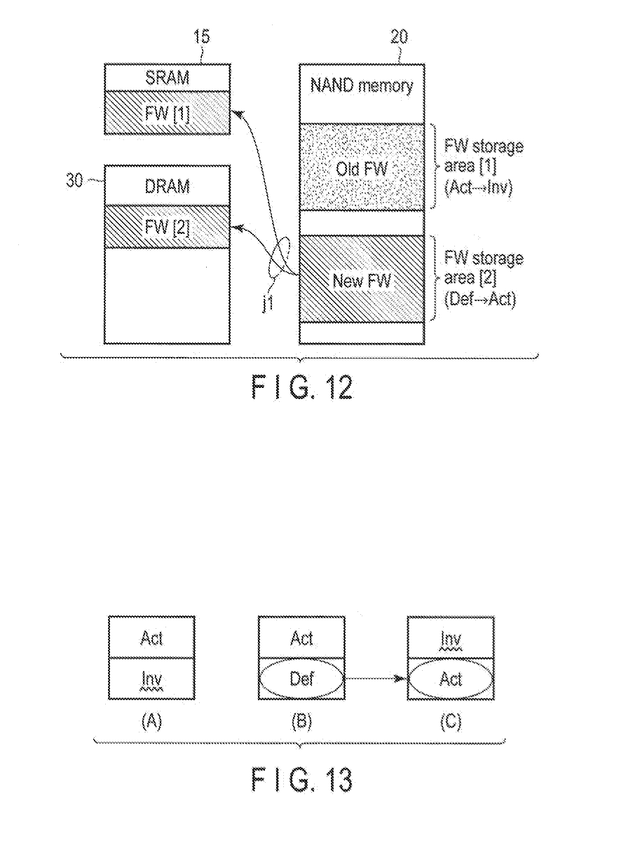

FIG. 12 illustrates an example of an operation performed by the controller 20 when firmware is loaded and activated (after new firmware is stored in the NAND memory 20 in accordance with a WRITE BUFFER command in which the content of the MODE field is 0Dh) upon the event specified by the MODE SPECIFIC field of the WRITE BUFFER command.

When firmware is loaded and activated upon the event which is registered at the time of reception of a WRITE BUFFER command in which the content of the MODE field is 0Dh and which is specified by the MODE SPECIFIC field of the WRITE BUFFER command, the controller 20 loads and activates the new firmware stored in a storage area in the deferred state (j1 in FIG. 12). At this time, the controller 20 sets the operational state of the storage area in which the new firmware is stored to the active state. Accordingly, the controller 20 sets the operational state of the storage area in the active state to the invalid state. After this setting, the new firmware is loaded and activated at the time of loading and activating firmware. For example, when new firmware is transferred with a WRITE BUFFER command in which the content of the MODE field is 0Dh, the new firmware is stored in the storage area in which the old firmware is stored. Until the event specified by the MODE SPECIFIC field of the WRITE BUFFER command occurs (or a WRITE BUFFER command in which the content of the MODE field is 0Fh is received), the update of firmware is suspended. Similarly, when new firmware is transferred with a WRITE BUFFER command in which the content of the MODE field is 05h, 07h, or 0Eh, the new firmware is stored in the storage area in which the old firmware is stored.

FIG. 13 illustrates transition of the operational states of the two storage areas in the NAND memory 20 corresponding to the transition of the operational state of the memory system 1 shown in FIG. 10 to FIG. 12.

In FIG. 13, (A) shows the operational state of the two storage areas in the NAND memory 20 when a WRITE BUFFER command in which the content of the MODE field is 0Dh is received. One of the two storage areas is in the active state. The other one is in the invalid state. Therefore, the new firmware transferred with this WRITE BUFFER command is stored in the storage area which is not in the active state, in other words, the storage area in the invalid state.

In FIG. 13, (B) shows the operational state of the two storage areas in the NAND memory 20 when the new firmware transferred with the WRITE BUFFER command is stored. As described above, the new firmware is stored in the storage area in the invalid state. The operational state of the storage area in which the new firmware is stored is changed from the invalid state to the deferred state. When new firmware is transferred with a WRITE BUFFER command when one of the two storage areas is in the active state and the other one is in the deferred state, the controller 20 stores the new firmware in the storage area in the deferred state. When new firmware is stored in the storage area, the controller 20 sets the operational state of the storage area to the invalid state once, and ultimately sets to the deferred state at the time of completing the storage of the new firmware. Thus, when the storage of new firmware in a storage area in the deferred state has been unsuccessful, the operational state of the storage area is set to the invalid state. The firmware stored in the storage area is made unusable.

In FIG. 13, (C) shows the operational states of the two storage areas of the NAND memory 20 when firmware is loaded and activated upon the event specified by the MODE SPECIFIC field of a WRITE BUFFER command (in which the content of the MODE field is 0Dh). In this case, out of the two storage areas, the new firmware stored in the storage area in the deferred state is loaded and activated. The operational state of the storage area in which the new firmware is stored is changed from the deferred state to the active state. Accordingly, the operational state of the storage area in the active state is changed to the invalid state.

Thus, the controller 20 is capable of suspending the update of firmware until the timing desired by the user comes by appropriately setting the operational state of the two storage areas of the NAND memory 20 and separately using the two storage areas depending on the situation. In other words, the controller 20 is capable of maintaining to apply the old firmware until the timing desired by the user comes.

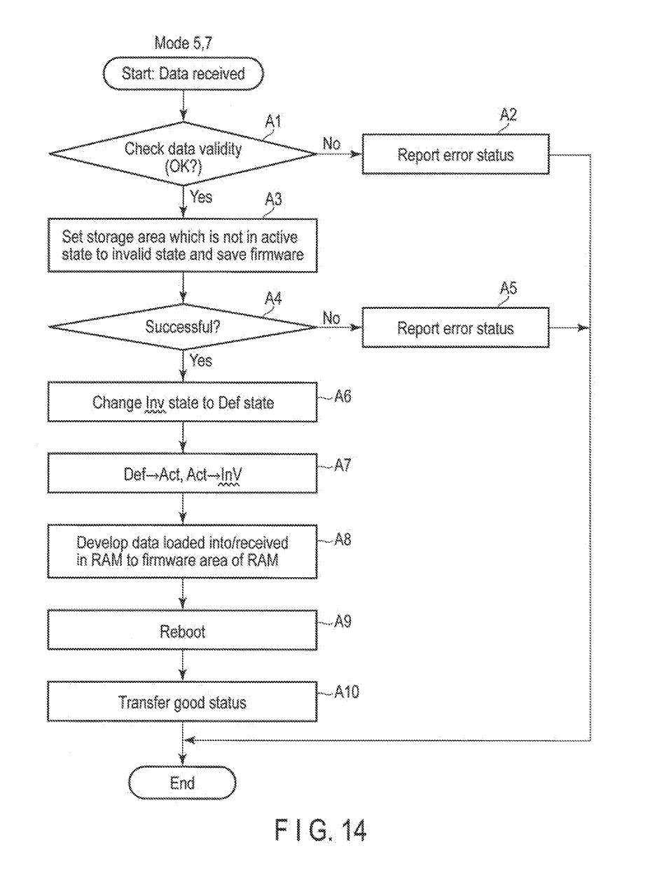

FIG. 14 is a flowchart showing the flow of an operation performed by the memory system 1 when a WRITE BUFFER command in which the content of the MODE field is 05h or 07h is received.

When the WRITE BUFFER command in which the content of the MODE field is 05h or 07h is received, the controller 20 checks the validity of new firmware transferred with this WRITE BUFFER command (step A1). When the validity is not confirmed (No in step A1), the controller 20 reports an error status to the host device 2 (step A2).

When the validity is confirmed (Yes in step A1), the controller 20 changes, out of the two storage areas for firmware in the NAND memory 20, the operational state of a storage area which is not in the active state to the invalid state, and stores the new firmware in this storage area (step A3). The controller 20 determines whether or not the storage of the new firmware is successful (step A4). When the storage of the new firmware is determined to be unsuccessful (No in step A4), the controller 20 reports an error status to the host device 2 (step A5).

When the storage of the new firmware is determined to be successful (Yes in step A4), the controller 20 changes the operational state of the storage area which has been invalidated in step A3 to the deferred state (step A6). Subsequently, the controller 20 changes the operational state of the storage area in the deferred state to the active state, and the operational state of the storage area in the active state to the invalid state (step A7).

The controller 20 develops the new firmware which is temporarily loaded into or received in the DRAM 30 to the firmware areas of the SRAM 15 and the DRAM 30, and reboots the new firmware (step A8 and step A9). The controller 20 reports a completion status to the host device 2 (step A10).

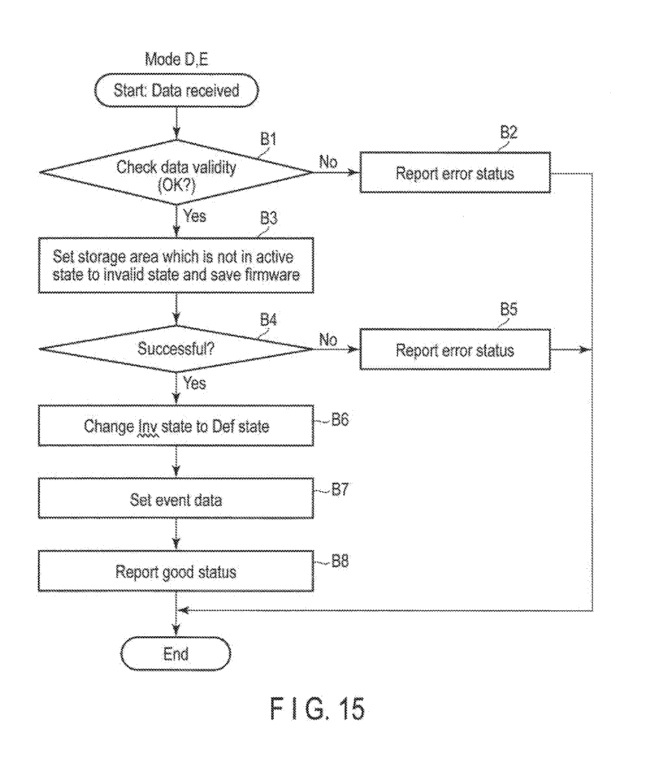

FIG. 15 is a flowchart showing the flow of an operation performed by the memory system 1 when a WRITE BUFFER command in which the content of the MODE field is 0Dh or 0Eh is received.

When the WRITE BUFFER command in which the content of the MODE field is 0Dh or 0Eh is received, the controller 20 checks the validity of new firmware transferred with this WRITE BUFFER command (step B1). When the validity is not confirmed (No in step B1), the controller 20 reports an error status to the host device 2 (step B2).

When the validity is confirmed (Yes in step B1), the controller 20 changes, out of the two storage areas for firmware in the NAND memory 20, the operational state of a storage area which is not in the active state to the invalid state, and stores the new firmware in the storage area (step B3). The controller 20 determines whether or not the storage of the new firmware is successful (step B4). When the storage of the new firmware is determined to be unsuccessful (No in step B4), the controller 20 reports an error status to the host device 2 (step B5).

When the storage of the new firmware has been successful (Yes in step B4), the controller 20 changes the operational state of the storage area which has been invalidated in step B3 to the deferred state (step B6). At this time, the controller 20 registers the event specified by the MODE SPECIFIC field (step B7). The controller 20 reports a completion status to the host device 2 (step B8).

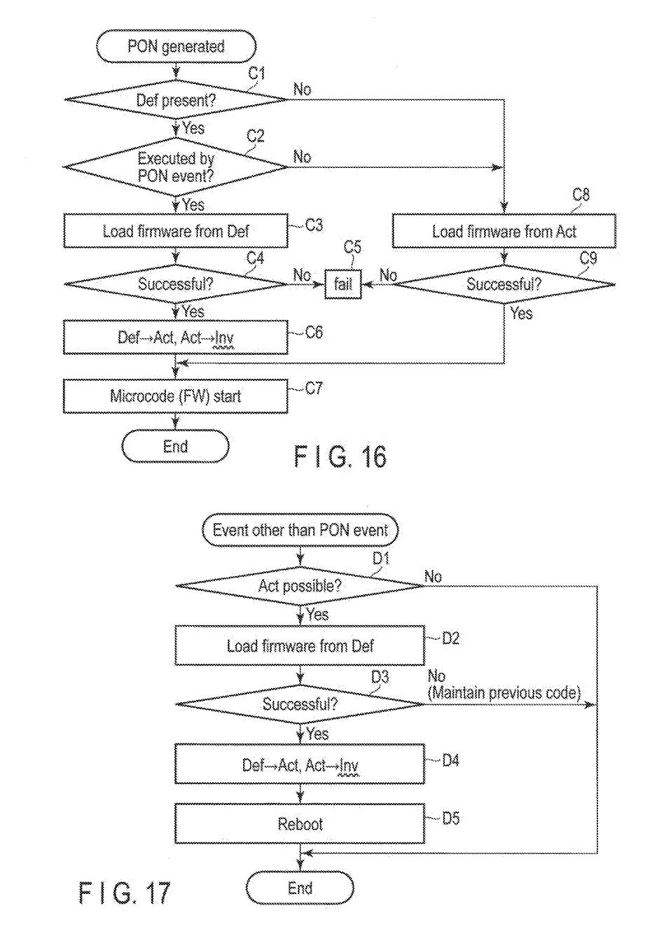

FIG. 16 is a flowchart showing the flow of an operation performed by the memory system 1 when a power-on event occurs.

When a power-on event occurs, the controller 20 determines whether or not a storage area in the deferred state is present in the two storage areas for firmware in the NAND memory 20 (step C1). When a storage area in the deferred state is present (Yes in step C1), the controller 20 determines whether or not the new firmware stored in the storage area in the deferred state should be loaded and activated (step C2). The new firmware should not be loaded from the storage area in the deferred state or be activated when the firmware of the storage area is transferred with a WRITE BUFFER command in which the content of the MODE field is 0Dh and further power-on is not specified as an event for performing loading and activation by the MODE SPECIFIC field of the WRITE BUFFER command.

When the controller 20 determines that the new firmware should be loaded from the storage area in the deferred state and be activated (Yes in step C2), the controller 20 loads the firmware from the storage area in the deferred state (step C3). The controller 20 determines whether or not the loading of the firmware is successful (step C4). When the loading of the firmware is determined to be unsuccessful (No in step C4), the controller 20 terminates the process for power-on (step C5). When the loading of the firmware is determined to be successful (Yes in step C4), the controller 20 changes the operational state of the storage area in the deferred state to the active state, and the operational state of the storage area in the active state to the invalid state (step C6). Then, the controller 20 activates the firmware (step C7).

When no storage area is in the deferred state (No in step C1), or when the controller 20 determines that the firmware should not be loaded from the storage area in the deferred state or be activated by a power-on event (No in step C2), the controller 20 loads firmware from the storage area in the active state (step C8). The controller 20 determines whether or not the loading of the firmware is successful (step C9). When the loading of the firmware is determined to be unsuccessful (No in step C9), the controller 20 terminates the process for power-on (step C5). When the loading of the firmware is determined to be successful (Yes in step C9), the controller 20 activates the firmware (step C7).

FIG. 17 is a flowchart showing the flow of an operation performed by the memory system 1 when an event (for causing firmware to be loaded and activated) other than a power-on event occurs in a state where new unapplied firmware is present.

When the event (for causing firmware to be loaded and activated) other than a power-on event occurs in the state where a storage area in the deferred state is present, the controller 20 determines whether or not it is possible to load and activate the new firmware stored in the storage area in the deferred state (step D1). It is impossible to load and activate the new firmware stored in the storage area in the deferred state when the firmware of the storage area is transferred with a WRITE BUFFER command in which the content of the MODE field is 0Dh and no event is specified as the event for performing loading and activation by the MODE SPECIFIC field of the WRITE BUFFER command.

When the controller 20 determines that the new firmware should be loaded from the storage area in the deferred state and activated (Yes in step D1), the controller 20 loads the firmware from the storage area in the deferred state (step D2).

The controller 20 determines whether or not the loading of the firmware is successful (step D4). When the loading of the firmware is determined to be unsuccessful (No in step D3), the controller 20 terminates the process related to the occurring event including restarting of the firmware. In this case, the current firmware remains to be applied. When the loading of the firmware is determined to be successful (Yes in step D3), the controller 20 changes the operational state of the storage area in the deferred state to the active state and the operational state of the storage area in the active state to the invalid state (step D4). Then, the controller 20 reboots the firmware (step D5).

As described above, according to the memory system 1 of the present embodiment, firmware can be updated at the timing desired by the user, in other words, when the event designated by the user occurs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. A memory system, comprising:
a nonvolatile memory including first and second regions for storing firmware; and
a controller configured to access the nonvolatile memory based on a command from a host device, wherein
when the controller receives new firmware along with an update command and old firmware is stored in the first region, the controller stores the new firmware in the second region, and
when execution of firmware is triggered by an event specified by the update command after the new firmware has been stored, the controller executes the new firmware, and
when execution of firmware is triggered by an event that is not specified by the update command after the new firmware has been stored, the controller executes the old firmware.

2. The memory system according to claim 1, wherein
when the controller executes the new firmware, the controller invalidates the old firmware.

3. The memory system according to claim 2, wherein
the controller is further configured to set operational states of the first and second regions, such that
an operational state of the first region is set to be in a first state when the old firmware has been activated,
an operational state of the second region is set to be in a second state when the new firmware is stored in the second region,
an operational state of the second region is set to be in the first state when the new firmware therein is executed, and
an operational state of the second region is set to be in a third state when the old firmware is invalidated.

4. The memory system according to claim 1, further comprising:
a volatile memory, wherein
the controller loads at least part of the new and old firmware in the volatile memory to execute the new and old firmware, respectively.

5. The memory system according to claim 1, wherein
when the controller receives the new firmware along with a second update command and the old firmware is stored in the first region, the controller stores the new firmware in the second region and further executes the new firmware, instead of the old firmware.

6. The memory system according to claim 5, wherein
the storage of the new firmware received along with the second update command in the second region and the execution of the new firmware are carried out in parallel.

7. The memory system according to claim 5, wherein
the execution of the new firmware is carried out upon completion of the storage of the new firmware received along with the second update command in the second region.

8. The memory system according to claim 1, wherein
when the controller receives the new firmware along with a third update command and the old firmware is stored in the first region, the controller executes the new firmware without storing the new firmware in the second region.

9. The memory system according to claim 1, wherein
the update command is a WRITE BUFFER command that is in accordance with small computer system interface (SCSI) standard and includes a value of “0Dh” in a mode field thereof.

10. The memory system according to claim 1, wherein
the event specified by the update command includes at least one of a power-on of the memory system and a hard reset of the memory system.

11. A method for updating firmware stored in a memory system that includes a nonvolatile memory having a first region that stores old firmware and a second region, the method comprising:
receiving new firmware along with an update command;
storing the new firmware in the second region of the nonvolatile memory;
when an event to trigger execution of firmware that is specified by the update command occurs after the new firmware has been stored, executing the new firmware; and
when an event to trigger execution of firmware that is not specified by the update command occurs after the new firmware has been stored, executing the old firmware.

12. The method according to claim 11, further comprising:
when the new firmware is executed, invalidating the old firmware.

13. The method according to claim 11, wherein
the memory system also includes a volatile memory,
when the new firmware is executed, at least part of the new firmware is loaded in the volatile memory,
when the old firmware is executed, at least part of the old firmware is loaded in the volatile memory.

14. The method according to claim 11, wherein
the update command is a WRITE BUFFER command that is in accordance with small computer system interface (SCSI) standard and includes a value of “0Dh” in a mode field thereof.

15. The method according to claim 11, wherein
the event specified by the update command includes at least one of a power-on of the memory system and a hard reset of the memory system

16. A method for updating firmware stored in a memory system that includes a nonvolatile memory having a first region that stores old firmware and a second region, the method comprising:
receiving new firmware along with an update command;
when the update command is a first update command,
storing the new firmware in the second region of the nonvolatile memory,
when an event to trigger execution of firmware that is specified by the first update command occurs after the new firmware has been stored, executing the new firmware, and
when an event to trigger execution of firmware that is not specified by the first update command occurs after the new firmware has been stored, executing the old firmware; and
when the update command is a second update command, storing the new firmware in the second region and executing the new firmware.

17. The method according to claim 16, wherein
the storage of the new firmware received along with the second update command in the second region and the execution of the new firmware are carried out in parallel.

18. The method according to claim 16, wherein
the execution of the new firmware is carried out upon completion of the storage of the new firmware received along with the second update command in the second region.

19. The method according to claim 16, further comprising:
when the update command is a third update command, executing the new firmware without storing the new firmware in the second region.

20. The method according to claim 16, wherein
the event specified by the first update command includes at least one of a power-on of the memory system and a hard reset of the memory system.
